(19) United States
(12) Patent Application Publication
(10) Pub. No.: US 2006/0265382 A1
(43) Pub. Date: Nov. 23, 2006

(54) Method and system of managing electronic data

(75) Inventors: Frederick Armanino, San Antonio, TX (US); Anthony Merritt, San Ramon, CA (US); Mengfeng Tsai, Fremont, CA (US); Theresa Lees, Sunnyvale, CA (US)

Correspondence Address: BROOKS KUSHMAN P.C., 1000 TOWN CENTER, TWENTY-SECOND FLOOR, SOUTHFIELD, MI, 48075, US

(73) Assignee: SBC Knowledge Ventures, L.P., Reno, NV (US)

(21) Appl. No.: 11/130,773

(22) Filed: May 17, 2005

(51) Int. Cl. G06F 7/00

(52) U.S. Cl. 707/10

(57) ABSTRACT

A method and system of managing data. The method and system including managing data transported to a server for processing and subsequent transmission, after processing, to one or more clients thereof. The method and system including instructing the server to expect certain data and to process the expected data according to predefined parameters.

### BACKGROUND OF THE INVENTION

1. Field of the Invention

The present invention relates to methods and systems of managing electronic data.

2. Background Art

A number of businesses and individuals store electronic data. The data may used for any number of operations and functions, such as to track inventory, monitor sales, store customer information, and the like. In some environments, large volumes of data (terabytes) may be stored. As more and more data is being stored, from more and more locations, management of the data can become a problem.

### BRIEF DESCRIPTION OF THE DRAWINGS

FIG. 1 illustrates a system of managing electronic data in accordance with one non-limiting aspect of the present invention; and

FIG. 2 illustrates a flowchart of a method of managing electronic data in accordance with one non-limiting aspect of the present invention.

### DETAILED DESCRIPTION OF THE PREFERRED EMBODIMENT(S)

One non-limiting aspect of the present invention relates to a method of managing data. The method may include instructing a server to expect electronic data from one or more network nodes in advance of such data being received by the server The method may include instructing the server to condition the expected data according to predefined parameters, such as according to predefine parameters associated with facilitating access to the data by one or more clients. The method may include, upon the server receiving data from one or more network nodes, determining whether the received data was expected and automatically conditioning the expected data according to the predefined parameters so as to facilitate access thereto by one or more clients.

The method may include conditioning the expected data into a common platform, limiting access to the conditioned data until the data expected from each node is conditioned, notifying the one or more clients when access to the conditioned data is available, and optionally, archiving the conditioned data to clear space for conditioning additional data.

The method may include receiving data from the nodes according to a number of different data formats and conditioning the number of data formats into a common format to facilitate access by the one or more clients.

The method may include logging the data received by the server and determining whether the data was expected as function thereof.

The method may include receiving compressed data from the nodes and conditioning the compressed data into uncompressed data to facilitate access by the one or more clients.

The method may include receiving the data in a landing zone folder, conditioning the expected data into a working folder from which the conditioned data is accessible by the one or more clients, and archiving the conditioned data in a archive folder, the folders being associated with the server.

The method may include instructing the server to expect one or more files from one or more of the nodes and conditioning the expected files only after the expected files are received from each of the corresponding nodes.

Another non-limiting aspect of the present invention relates to a system of managing data. The system may include a number of network nodes and a client in communication with a server such that the server may be configured to receive data from the nodes and to transport data to the client. The server may be configured to expect electronic data from one or more network nodes in advance of such data being received by the server, to condition the expected data according to predefined parameters, and upon the server receiving data from one or more network nodes, to determine whether the received data was expected and to automatically condition the expected data according to the predefined parameters so as to facilitate the transportation of the conditioned data to the client.

The above features and advantages, along with other features and advantages of the present invention, are readily apparent from the following detailed description of the invention when taken in connection with the accompanying drawings.

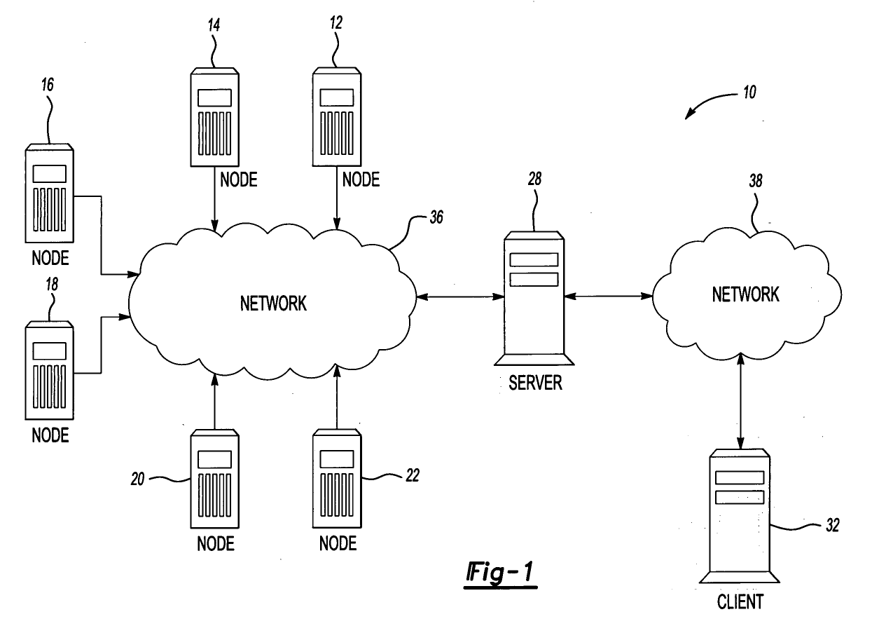

FIG. 1 illustrates a system 10 of managing electronic data in accordance with one non-limiting aspect of the present invention. The system 10 relates to any number environments where electronic data from one or more network nodes 12-22 may be stored on a server 28 and downloaded or otherwise transferred therefrom to one or more clients 32. The system 10 may apply to businesses, individuals, and other entities which store electronic data.

The electronic data may relate to any form of electronic data which may be transmitted from the nodes 12-22 over a network 36 to the server 28. The data may be files, raw data streams, binary, encrypted, compressed, and other electronic forms of information, such as text, application binary, highly formatted text, multi-media, audio, video, and any other form of electronic material. The data may be associated with any number of protocols, formats, programs, software applications, and other operation platforms and systems.

The nodes 12-22 may include any type of unit or entity which can transmit electronic data for storage on the server 28. The nodes may correspond with computers and/or other devices which collect or otherwise receive electronic data. The nodes may be programmed by users, the server 28, and/or the client 32 to automatically transmit electronic data to the server 28 for storage and/or processing.

The server 28 may include any type of unit or entity which can store and process electronic data. The sever 28 may be a database or other electronic entity. It may include interfaces and other access features to permit a system operator or other entity to program the operation thereof. The server 28 may be a standalone unit which automatically executes software applications and/or which performs other logical exercises.

The client 32 may be an application, server, desktop or mobile computer, messaging bus (middleware), hand-held unit, or other device which may be configured to communicate with the server 28 over a network 38. It may include features for processing data received from the server 28, such as through the use of software applications and the like.

The networks 36-38 may be any type of network having sufficient capabilities for transferring data between any number of devices connected thereto. The networks 36-38 may be terrestrial and extraterrestrial systems. They may be based on wireline and/or wireless infrastructures and configured to transport electronic signals according to any number of protocols, formats, and operating platforms and systems.

The system 10 shown in FIG. 1 is provided for exemplary purposes and is not intended to limit the scope and contemplation of the present invention. The present invention fully contemplates the system 10 including more or less of these features. In particular, the present invention contemplates the system including any number of nodes 12-22, servers 28, and clients 32. Moreover, the networks 36-38 need not be separate networks and the server 28 and client 32 are not always required to be remotely located from each other. As one skilled in the art will appreciated, the client-server relationship contemplates any number of configurations, and is not necessarily limited to the foregoing.

In accordance with one non-limiting aspect of the present invention, the system 10 may be configured to support digital subscriber line (DSL) systems. The nodes 12-22 may be Digital Subscriber Line Multiplexers (DSLAMs) or other customer interface/support device which connect any number of customer locations to the network 36 or other networks, such as the internet. The system 10 may include any number of such DSLAMs (hundred, thousands, etc.). The DSLAMs may be configured by a system operator (not shown) to support any number of applications and features associated with provide high-speed data applications.

The DSLAMs may be configured to collect information on customer service usage and any number of other operating characteristics. Configuration profiles, customer settings, and other information may be electronically stored on the DSLAMs for controlling the operation thereof. Each DSLAM may be programmed by the system operator and/or requested by another device in the system (server, client, or other) to provide such information in the form of electronic data to the server on a periodic, regular, or irregular basis.

The server 28 may mange receipt of electronic data from the DSLAMs to ensure completeness for clients, to monitor or manage the operation thereof, to collect performance and capacity information, and any number of other operations associated with storing and processing data from the nodes 12-22 for subsequent use by the client 32. For example, data received from the DSLAMs may be confirmed for completeness, prepared for the clients, transferred to the client to maintain efficient processing, as described below in more detail.

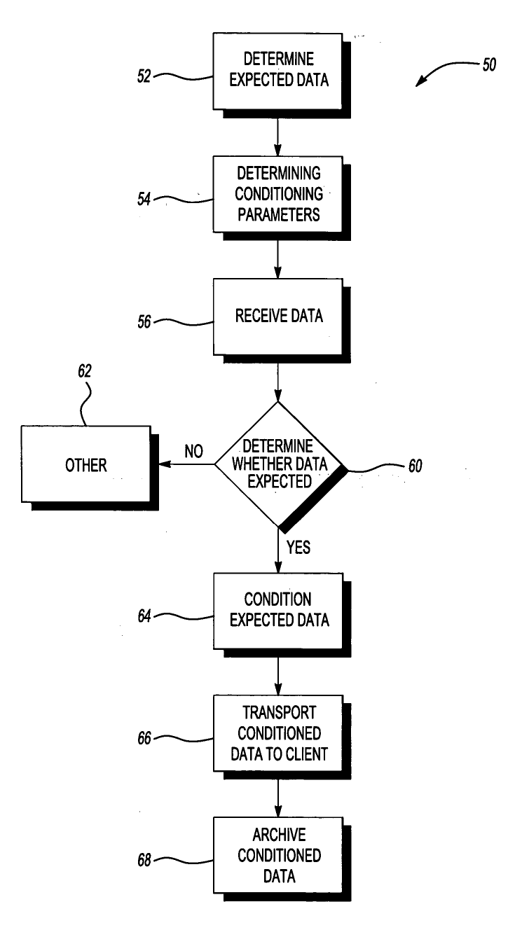

FIG. 2 illustrates a flowchart 50 of a method of managing electronic data in accordance with one non-limiting aspect of the present invention. The method generally relates to managing electronic data transmitted to the sever 28 for storage and processing and subsequent transport to the client 32.

Block 52 relates to instructing the server 28 to expect data from one or more of the nodes 12-22. The instructions may be communicated thereto from the system operator through an interface (not shown) associated with the server 28 and/or through any other means, such as through signals communicated over the networks 36-38 from the system operator or the client 32.

The instructions may be coordinated with data transmission settings of the nodes 12-22. For example, one or more of the nodes 12-22 may be configured to transmit data to the server on a periodic basis. The server 28 may be instructed to expect this data. The instructions may include identifiers for each of the nodes 12-22 and the electronic data expected therefrom. Optionally, timestamps and other time-based indicators may be included to instruct the server 28 when to expect to the data.

Block 54 relates to providing the server 28 with one or more conditioning instructions. The conditioning instructions may be provided to the server in a manner similar to the manner in which the server 28 is instructed to expect the data. The conditioning instructions may be coordinated with the identifiers and indicators associated with the nodes 12-22 and data. The server 28 may be instructed to correlate the conditioning instructions with the data identifiers and indicators. The server 28 may condition the expected data according to any number of parameters and operating parameters.

For example, the nodes 12-22 may operate according to any number of differing operating systems and/or formats. The conditioning instructions may instruct the server 28 to convert or otherwise manipulate the data into a common format, such as one which is compatible with the client 32. Likewise, the nodes 12-22 may transmit data according to any number of different compression settings or protocols. The conditioning instructions may instruct the server 28 to convert or otherwise manipulate the compressed data into uncompressed data and/or to reconfigure the compressed data into compression a standard or protocol associated with the client 32.

The conditioning instructions may include instructions for performing other operations, such as for ungrouping or uncompressing files transport from the nodes 12-22 in a group or batch to individual files (i.e. to support un-tarring applications and the like). The conditioning instructions may include instructions for forwarding files/data to archiving systems, test systems, clients, or an other downstream device.

Block 56 relates to the server 28 receiving data from one or more of the nodes 12-22. The data may be expected or unexpected data. The expected data may correspond with regular transmissions from the nodes 12-22 that are expected according to a schedule or other predefined interval. The unexpected data may be other date which is accidentally, unintentionally, or otherwise transmitted to the server and which is not to be managed in accordance with the present invention.

Information associated with the received data may be logged by the server 28. For example, the information may include a node identifier, timestamp, data descriptor, size, transmission duration, directory location, session identifier, and other information related to the data. This information may be used, as described below in more detail, to facilitate determining whether the received data was expected or unexpected. This or similar information may be used to facilitate instructing the server 28 to expect the data.

The node identifier may be an indicator, signature, or other feature used for identifying the node 12-22 responsible for transmitting the data to the server 28. The timestamp may indicate at time at which the data was transmitted from the server 28 and/or it may indicate a time at which the data was received by the server 28. The transmission duration may indicate a length of time taken to transmit the data from the node 12-22 to the server 28. The directory location may indicate a directory on the server 28 for which the nodes is to locate the associated data. The session identifier may confirm that only authorized sessions are managed by the server 28, such as by requiring a user's ID to access the server, remote host-names of the nodes 12-22, etc.

Block 60 relates to determining whether the received data was expected or unexpected. The server 28 may be configured to match the received data with the data it was instructed to expect and to determine whether the data was expected or unexpected as a function thereof. The server 28 may include a processor or other self-executing application to automatically make this determination. The information logged with receipt of the data may be compared by the server 28 with the instructions on expected data to determine whether the data was expected or unexpected.

Block 62 relates to exiting the flowchart in response to receipt of such data. This may include instructing the server 28 to perform other operations on the data, such as by controlling the server 28 according to instructions included within the unexpected data.

Block 64 relates to conditioning the expected data according the conditioning instructions. The conditioning instructions may include any number of operations, a number of which are described above with respect to block 54. The conditioning may relate to manipulating or otherwise processing the received data into a condition more suitable for transmission to the client 32 and/or processing or otherwise manipulating the data to ameliorate processing burdens on the client 32.

Block 66 relates to transmitting the conditioned data to the client 32. The transmission may occur over the network 38. It may be instigated by the client 32 and/or the server 28. For example, the server 28 may be configured to transport batches of electronic files to the client 32 upon completion of the conditioning thereof. In more detail, a grouping of some or all of the nodes 12-22 may be configured to transmit one or more files to the server 28 on a periodic basis, such as to back-up data stored on the nodes 12-22. The server 28 may be instructed to expect the files from one or more of the nodes 12-22, to collect one or more of the files from each of the nodes 12-22 into a common file or database, and to transmit the collected files to the client 32. The server 28 may be configured to efficiently transport the conditioned data to the client immediately upon completing conditioning of the expected data, as opposed to thereafter waiting until some predefined period in time to transport the condition data.

Block 68 relates to archiving the data transmitted to the client 32. The archiving may include storing the data on a memory associated with the server 28, which may be connected thereto or located remotely therefrom. The archiving may corresponding with a file folder configuration of the server 28. For example, the server 28 may be configured to receive data in a landing-zone folder, to process the received data and temporarily store it in a working folder (i.e. while it awaits transmission to the client), and to permanently store it in an archive folder.

Of course, the present invention contemplates any number of configurations for managing the data and is not necessarily limited to the foregoing. Moreover, additional processes and features may be included to facilitate managing the data. For example, the server 28 may be instructed to expect multiple sets of data from multiple nodes and to separately condition the data for transmission to the same and/or different client 32.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of managing data, the method comprising:
instructing a server to expect electronic data from one or more network nodes in advance of such data being received by the server;
instructing the server to condition the expected data according to predefined parameters, the predefine parameters associated with facilitating access to the data by one or more clients; and
upon the server receiving data from one or more network nodes, determining whether the received data was expected and automatically conditioning the expected data according to the predefined parameters so as to facilitate access thereto by one or more clients.

2. The method of claim 1 further comprising:
conditioning the expected data into a common platform.

3. The method of claim 1 further comprising:
limiting access to the conditioned data until the data expected from each node is conditioned.

4. The method of claim 3 further comprising:
notifying the one or more clients when access to the conditioned data is available.

5. The method of claim 1 further comprising:
archiving the conditioned data to clear space for conditioning additional data.

6. The method of claim 1 further comprising:
receiving data from the nodes according to a number of different data formats and conditioning the number of data formats into a common format to facilitate access by the one or more clients.

7. The method of claim 1 further comprising logging the data received by the server and determining whether the data was expected as function thereof.

8. The method of claim 1 further comprising:
further comprising receiving compressed data from the nodes and conditioning the compressed data into uncompressed data to facilitate access by the one or more clients.

9. The method of claim 1 further comprising:
receiving the data in a landing zone folder, conditioning the expected data into a working folder from which the conditioned data is accessible by the one or more clients, and archiving the conditioned data in a archive folder, the folders being associated with the server.

10. The method of claim 1 further comprising:
instructing the server to expect one or more files from one or more of the nodes and conditioning the expected files only after the expected files are received from each of the corresponding nodes.

11. A system of managing data, the system comprising:
a number of network nodes and a client in communication with a server, the server configured to receive data from the nodes and to transport data to the client; and
wherein the server is configured to expect electronic data from one or more network nodes in advance of such data being received by the server, to condition the expected data according to predefined parameters, and upon the server receiving data from one or more network nodes, to determine whether the received data was expected and to automatically condition the expected data according to the predefined parameters so as to facilitate the transportation of the conditioned data to the client.

12. The system of claim 11 wherein the server is configured for conditioning the expected data into a common platform.

13. The system of claim 11 wherein the server is configured for limiting access to the conditioned data until the data expected from each node is conditioned.

14. The system of claim 13 wherein the server is configured for notifying the one or more clients when access to the conditioned data is available.

15. The system of claim 11 wherein the server is configured for archiving the conditioned data to clear space for conditioning additional data.

16. The system of claim 11 wherein the server is configured for receiving data from the nodes according to a number of different data formats and conditioning the number of data formats into a common format to facilitate access by the one or more clients.

17. The system of claim 11 wherein the server is configured for logging the data received by the server and determining whether the data was expected as function thereof.

18. The system of claim 11 wherein the server is configured for receiving compressed data from the nodes and conditioning the compressed data into uncompressed data to facilitate access by the one or more clients.

19. The system of claim 11 wherein the server is configured for receiving the data in a landing zone folder, conditioning the expected data into a working folder from which the conditioned data is accessible by the one or more clients, and archiving the conditioned data in a archive folder, the folders being associated with the server.

20. The system of claim 11 wherein the server is configured for instructing the server to expect one or more files from one or more of the nodes and conditioning the expected files only after the expected files are received from each of the corresponding nodes.
